(19) United States
(12) Patent Application Publication
(10) Pub. No.: US 2007/0143479 A1
(43) Pub. Date: Jun. 21, 2007

(54) Systems and methods for centralized custodial control

(76) Inventors: Michael A. Putnam, Roswell, GA (US); Joseph A. Paonessa, Roswell, GA (US); James Allen Joy, Woodstock, GA (US); Philip Anthony Bleistine, Atlanta, GA (US); Wilton Job Pyle III, Marietta, GA (US)

Correspondence Address: KILPATRICK STOCKTON LLP, 1001 WEST FOURTH STREET, WINSTON-SALEM, NC, 27101, US

(21) Appl. No.: 11/303,641

(22) Filed: Dec. 16, 2005

(51) Int. Cl. G06F 15/173

(52) U.S. Cl. 709/226

(57) ABSTRACT

Systems and methods for centralized custodial control are desribed. One described custodial control system includes a primary controller having a first network adapter, the primary controller configured to receive a custodial control parameter and generate and transmit a custodial control command, and a plurality of remote nodes each having a network adapter configured to receive the custodial control command and to implement a custodial control process based at least in part on the custodial control command. Various methods for administering a custodial control system are also described.

### FIELD OF THE INVENTION

This invention relates generally to systems and methods for controlling access to electronic devices. More particularly, embodiments of this invention relate to systems and methods for centralized custodial control.

### BACKGROUND OF THE INVENTION

The typical custodian owns a variety of entertainment devices. These devices include televisions, game consoles, computers, and stereos. It can be challenging for a custodian to monitor and control the amount of time that a user spends using each of these devices.

A custodian may use various approaches in controlling access to these devices, including, for example, placing these devices in a common room. Unfortunately, it may be difficult to find a room with enough space to accommodate the equipment, and having all of the equipment in one room may be inconvenient to the custodian and to the user. Further, some of the devices that the custodian may wish to control are portable. This only serves to exacerbate the custodian's challenge in controlling access to the device.

Systems and methods for centrally managing devices scattered throughout a home and for managing portable devices are needed.

### SUMMARY

Embodiments of this invention provide systems and methods for centralized custodial control. In one embodiment, a custodial control system comprises a primary controller having a first network adapter, the primary controller configured to receive a custodial control parameter and generate and transmit a custodial control command, and a plurality of remote nodes each having a network adapter configured to receive the custodial control command and to implement a custodial control process based at least in part on the custodial control command. Another embodiment of this invention comprises a method for administering a custodial control system. In yet another embodiment, a computer-readable medium (such as, for example random access memory or a computer disk) comprises code for carrying out such a method.

These illustrative embodiments are mentioned not to limit or define the invention, but to provide examples to aid understanding thereof. Illustrative embodiments are discussed in the Detailed Description, and further description of the invention is provided there. Advantages offered by the various embodiments of this invention may be further understood by examining this specification.

### FIGURES

These and other features, aspects, and advantages of this invention are better understood when the following Detailed Description is read with reference to the accompanying drawings, wherein:

FIG. 1 is a block diagram of an illustrative environment for implementation of an embodiment of this invention;

FIG. 2 is a block diagram illustrating a game console control module in one embodiment of this invention;

FIG. 3 is a flowchart illustrating a method of identifying a new node in one embodiment of this invention; and

FIG. 4 is a flowchart illustrating a method of administration in one embodiment of this invention.

### DETAILED DESCRIPTION

Embodiments of this invention provide systems and methods for centralized custodial control. For example, embodiments of this invention may be used by a parent to control the amount of time a child watches television or plays a video game.

### Illustrative Custodial Control System

One custodial control system according to an embodiment of this invention includes a primary control node in the form of a handheld device. The handheld device includes a processor, memory, software, including firmware, and a wireless network interface card (NIC). The primary control node accepts inputs regarding the schedule of availability of particular devices under the control of the primary control node. The schedule of availability may vary for different users or classes of users of the devices under the system's control. The primary node then distributes the appropriate schedule and any associated information to each of the remote nodes.

The system also includes a plurality of remote nodes for controlling the various devices. The remote nodes may utilize various strategies for controlling the devices, such as controlling power to the device or controlling the interface between the device and a display.

For instance, the system may include a remote node for controlling the times when certain members of the household can watch television. The remote node is installed between the antenna, cable box, or other television input device and the television. The outputs from the input device, such as RCA-type jacks, are plugged into the remote node, and additional cables run from the remote node to the television.

When a user wishes to view the television, the user enters an identifying code into the primary controller. The remote node then accesses the schedule received from the primary node to determine whether or not the user is authorized to use the television at that time. If the user is authorized, the remote node enables the television, letting the signal pass from the input to the television. If the user is not authorized, the remote node blocks the input signal from the television.

### System Design

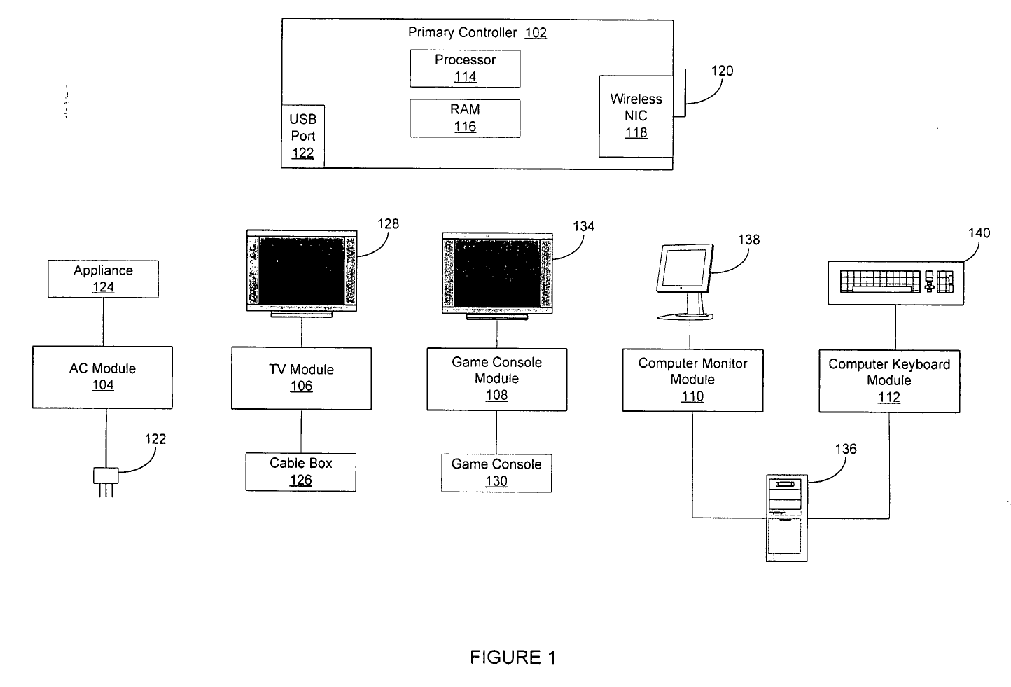

FIG. 1 is a block diagram illustrating a custodial control system in one embodiment of this invention. The system shown in FIG. 1 is an electronic custodial control system used to allow or deny operation of various electrical or electronic products in the home. This system is, or may be, composed of any number of interrelated individual hardware, documentation, and firmware or software modules. In the embodiment shown, the custodial control system includes a primary controller 102. The primary controller 102 is in wireless communication with a plurality of remote nodes. For instance, the primary controller 102 may include a wireless network interface card or other wireless network adapter. In other embodiments, the primary controller 102 may include other types of network adapters, such as a wired network adapter card or a powerline network adapter card. The plurality of remote nodes includes an AC module 104, and TV module 106, a game console module 108, a computer monitor module 110, and a computer keyboard module 112. The remote nodes shown in FIG. 1 are only examples of the remote nodes that may be implemented in an embodiment of this invention. Other nodes and other combinations of nodes may also be implemented.

The primary controller 102 and the various modules 104-112 may be powered by their own power source, such as by AA or AAA batteries. For example, the primary controller 102 may include rechargeable nickel-metal hydride batteries. The rechargeable batteries are contained in the primary controller 102 in such a way that they are not user-serviceable. The primary controller nickel-metal hydride batteries are charged via a cradle-style battery charger designed in such a way that the primary controller 102 fits securely during the charging process yet is easily removable by the user during use. The remote modules may alternatively rely on a power source provided by the component to which they are attached. For example, the computer keyboard module 112 may include internal batteries or may rely on power from the port to which it is connected, such as a USB port.

The primary controller 102 may comprise a handheld device. The primary controller 102 may instead comprise a desktop or notebook computer executing control and communication software in accordance with an embodiment of this invention.

Each of the remote nodes 104-112 shown also includes a wireless NIC, processor, and memory. The internal circuitry of the remote nodes control the availability of the signals at its output via wireless control signals from the primary controller 102. In other embodiments, the remote nodes 104-112 communicate via wired communications.

The remote nodes may incorporate an external button labeled, “Synchronization.” The Synchronization button provides positive conformation to the primary controller 102 that a particular module is intended to be a part of a given system. Typically, when a new module is introduced to a system, the primary controller 102 will automatically detect when a new compatible module is within range. However, the primary controller 102 may not know whether this new module is intended as part of its network or another similar system in close proximity. In order to resolve this uncertainty, the primary controller 102 may prompt the system administrator to locate the new module and depress its synchronization button to confirm that this module belongs in the system. If the newly introduced module is intended to be a part of a given system, then the administrator will likely know where it is located and have access to the synchronization button. If the newly introduced module is not intended to be a part of the system, the administrator will not add it to the list of available modules. Such an embodiment may be useful in an area where many people live in close proximity, such as in an apartment complex. The system may alternatively implement a key system that allows an administrator to distribute a key, such as a random number, which can be entered into each of the modules to identify them as part of a system in a manner analogous to the use of an SSID (Service Set Identifier) in a wireless network.

The remote nodes 104-112 may monitor battery condition and report the battery condition via wireless communications back to the primary controller 102. The remote nodes may be also designed in such a way that tampering is monitored and reported via wireless communications back to the primary controller 102. This sensing may either be, for example, a detection of cover removal, or detection of excessive motion lasting more than a specified amount of time.

The remote nodes 104-112 may retain an internal log of status where battery condition, tampering events, network connection status and connect/disconnect events are stored with time/date stamps. When requested by the primary controller 102, this log can be communicated back to the controller 102. Once the primary controller has successfully read the log, the remote node may delete the log entries. This log may be retained indefinitely in the event battery power is lost.

In the embodiment shown in FIG. 1, the primary controller 102 is the main user interface device for the system. The primary controller 102 receives user scheduling and control information, and wirelessly communicates commands based on this input to the various other modules 104-112.

The system has a user that is designated as the administrator. The administrator programs the primary controller 102 with the desired control schedules for each control module 103-112 located on the network, on a per-user or user-group basis. Access to the various allowed scheduled access lists will be based on user passwords. The primary controller 102 can be programmed for an entire year in advance, and may be capable of repeating a weekly, monthly or yearly schedule.

The primary controller 102 includes a processor 114. The processor 114 is in communication with a computer-readable medium, random access memory (RAM) 116. The processor 114 executes computer-executable program instructions stored in memory, such as scheduling and communication software. Such processors may comprise a microprocessor, an ASIC, and state machines. Such processors comprise, or may be in communication with, other media, for example a hard drive or flash read-only memory (ROM), which stores instructions that, when executed by the processor 114, cause the processor 114 to perform the steps described herein.

Embodiments of computer-readable media include, but are not limited to, electronic, optical, magnetic, or other storage or transmission device capable of providing a processor, such as the processor 114, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other suitable medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The primary controller 102 shown in FIG. 1 also includes a wireless NIC 118. The wireless NIC 118 allows the primary controller 102 to communicate with the modules 104-112. The primary controller 102 and modules 104-112 may communicate using a wireless mesh network, such as a mesh network based on the ZigBee wireless standard. ZigBee is a standard that provides network, security, and application support services operating on top of the IEEE 802.15.4 Medium Access Control (MAC) and Physical Layer (PHY) wireless standard. The NIC 118 is coupled to an antenna 120.

In another embodiment of this invention, the primary controller 102 and modules 104-112 communicate via a wired network. For instance, the primary controller 102 may communicate via Ethernet or by using the electrical transmission system within a building. For example, an administrator in a high-rise building may plug the primary controller 102 into an electrical outlet in the wall. The modules 104-112 are also plugged into electrical outlets in the wall. The administrator is then able to issue commands on the primary controller 102 that are relayed to the modules 104-112 via communication signals carried over the electrical system wiring.

The primary controller 102 also includes a universal serial bus (USB) adapter 122. The USB adapter 122 can be used for power, software and firmware upgrades, or other types of input and output. The primary controller may also include various other input and/or output elements. For instance, the primary controller 102 may include a display screen and a keyboard.

The primary controller 102 may incorporate a software-controlled keyboard, which will display as a virtual keyboard in a display area. Individual keys are selected by touching the display with a plastic stylus, finger, or other pointing device. The virtual keyboard area may be deactivated, thus freeing the display area for other display or touch sensitive activities. The keyboard may be formatted in a standard QWERTY format or as a numeric keyboard. Implementation of a software-controlled keyboard avoids the additional cost and reduced reliability of a physical alphanumeric keyboard. However, a physical keyboard may be used in addition to or instead of a software-controlled keyboard.

The primary controller 102 may be designed to sit in a cradle, which allows the primary controller 102 to receive power recharge and a computer connection whenever the controller 102 is placed in the cradle.

The primary controller 102 may receive input in various ways. For instance, scheduling and other commands may be entered directly using a keyboard and display on the controller. The primary controller 102 may also be programmed through use of a computer application. The computer application allows easy programming of the primary controller 102 by allowing the user to plan schedules and set up custom control scenarios for each external module 104-112 and download the information directly to the controller 102 via the USB port 122. The use of the computer application also facilitates an automatic synchronization feature, which acts to keep the data in the primary controller 102 and the data in the computer application consistent with each other, i.e., if changes are made on the primary controller 102, those changes can be uploaded to a computer. The computer application may operate on a standard PC, Linux, MAC, or any other computer a user wishes to use. The computer may include a specialized driver for communication with the primary controller 102 via the USB port. In another embodiment, the computer functions as the primary controller 102, communicating via wired or wireless communication with the remote modules 104-112.

The system shown in FIG. 1 includes an AC module 104. The AC module 104 is capable of controlling AC power sources. The AC module 104 is designed to receive AC power from a power source via a plug 122 and control the output of AC power signals to various household appliances, such as appliance 124. The appliance's AC power cord plugs into the AC module 104. As described below, the AC module 104 may be designed to prevent removal of the appliance's power cord from the AC module. The AC module 104 controls the availability of the output power based at least in part on wireless control signals from the primary controller 102. The AC module 104 captures the power plug of the appliance 124 in a lockable box to prevent access to the appliance 124 independent of the control of the AC module 104.

Multiple AC modules may be present in a system according to an embodiment of this invention. Also various types of AC modules may be utilized. For instance, in one system, three types of AC modules are implemented: a low-power AC module, operating at loads of 100 watts or less, a medium-power AC module operating at loads of 300 watts or less, and a high-power AC module, operating at loads of 500 watts or less.

The AC Module 104 may include colored indicator lights for signaling the status of the module 104. For example, under normal operating conditions, when such an AC module 104 is activated to deliver AC power, a green indicator indicates the availability of AC power. The module 104 may also be designed in a way to prevent damage to the module 104 in the event that its power handling capacity is exceeded. Such a module may contain an audible alarm that sounds continuously when its power capacity has been exceeded. If the power handling capacity has been exceeded, the module will immediately remove power from the load device, sound the alarm, light a red flashing indicator and send an alarm status message to the primary controller 102. The primary controller 102 may then display this alarm condition and sound its own audible alarm. Various methods may then be enabled to reset the alarm condition. For example, removing the AC input power from the alarming module for a few seconds.

Another embodiment includes a DC module for interrupting power provided by a DC power source. The DC power source may include, for instance, internal or external batteries, or some type of power brick for supplying power to a device.

The system shown in FIG. 1 also includes a television (TV) module 106. The television module 106 is designed to intercept and control a radio frequency (RF) signal that normally feeds a television's RF input. This is accomplished by connecting the RF signal source from a cable box 126, satellite, antenna, videocassette recorder (VCR), digital versatile disk (DVD) player, or other input device, into the television control module 106. The television 128 is then attached to the television control module 106. In other embodiments, the TV module 106 is designed to interrupt an optical (digital) signal or some other type of signal provided to a television.

A method is utilized in the television control module's design to prevent removal of the RF signal cables from the television control module 106. The internal circuitry of the television control module 106 controls the availability of the RF signal at its output via wireless control signals from the primary controller 102. One such module includes a standard 75-ohm coaxial interface as its RF signal input labeled as “Input Signal.” The module also includes a standard 75-ohm coaxial interface as its RF signal output labeled as “Output Signal.” Although described in terms of RF signals, the TV module 106 may also be used to control digital signals originating on conventional copper or optical cables.

The system also includes a game console module 108. The game console module 108 is designed to intercept and control video and audio output signals from different types of video game consoles, such as game console 130. This is accomplished by connecting the game console's output signals into the game control module 108. The game control module 108 provides these same signals on an output cable that can then be connected to the user's television 134.

For instance, the module 108 may include three standard RCA jack (female) interfaces as signal inputs. The jacks are colored in the standard colors for Video (Yellow), Audio Left (Red) and Audio Right (White) and are clearly labeled as “Input Signals.” The module also includes another group of three RCA jacks. These jacks are also colored in the standard colors for Video (Yellow), Audio Left (Red) and Audio Right (White) and are labeled as “Output Signals.” A method is utilized in the game control module's design that prevents removal of the game console's signal cables from the game control module 108.

The video channel of the game console module 108 may be compatible with standard NTSC Video signal levels. In such an embodiment, the module 108 does not distort or attenuate the video signal in a way that is visually detectable when commanded to connect. When commanded to disconnect, the video output shall drop to a level of at least 50 db below the original video signal level. Similarly, the two audio channels of the module 108 do not distort or attenuate the audio signal in a way that is audibly detectable when commanded to connect. When commanded to disconnect, the audio outputs drop to a level of at least 50 db below the original audio signal levels. In the event that battery power is lost, due to dead, low, or removed batteries, the three channels may be entirely disconnected.

The system may also utilize a combined television/game console control module as users often connect both television input and game console input to the same television. Also, such controller may be used with VCR, DVD, or other types of video players that may be used as inputs for televisions or other video monitors.

The system shown in FIG. 1 also includes a computer monitor module 110 and a computer keyboard module 112. These modules are connected to the video output port and keyboard port, respectively, of a computer 136.

The computer monitor module 110 is designed to intercept and control video and control output signals from the computer 136. This is accomplished by connecting the computer's video output signal into the computer monitor module 110. The computer monitor module 110 provides these same signals on an output cable that can then be connected to the user's computer monitor 138. A method is utilized in the computer monitor module's design that prevents removal of the computer's video cable from the computer monitor module 110. For example, the computer monitor module 110 may include a locking mechanism to mechanically capture the monitor cable so that the module 110 cannot be bypassed. The internal circuitry of the computer monitor module 110 controls the availability of the signals at its output via wireless control signals from the primary controller 102.

This module 110 may comprise a standard female 15-pin D-Sub jack as its signal input, labeled as “Input from Computer,” and another standard female 15-pin D-Sub jack as its signal output, labeled as “Output to Monitor.”

The signal channels shall be compatible with standard computer monitor signal levels. The module shall not distort or attenuate the video signal in a way that is visually detectable when commanded to connect. When commanded to disconnect, the video output shall drop to a level of at least 50 db below the original video signal level.

The computer keyboard module 112 is designed to intercept and control input/output signals from a standard computer keyboard, such as keyboard 140. This is accomplished by connecting the computer's keyboard cable into the computer keyboard module 112. The computer keyboard module 112 may include a locking mechanism to mechanically capture the keyboard cable so that the module 112 cannot be bypassed. The computer keyboard module 112 will provide these same signals on an output cable that can then be connected to the user's computer 136. A similar set of inputs and outputs may be utilized to control a wireless keyboard or USB device. A method utilized in the computer keyboard module's design prevents removal of the keyboard's cable from the computer keyboard module 112. The internal circuitry of the computer keyboard module 112 controls the availability of the signals at its output, via wireless control signals from the primary controller 102.

The system shown in FIG. 1 may comprise additional modules as well. For instance, a custodial control system according to an embodiment of this invention may include multiple primary control modules to allow a user to exercise control functions in various portions of the house. The system may also include different or additional control modules or other remote modules. The system may also include wired or wireless repeaters to extend the range of the system.

In one embodiment of this invention, the primary controller 102 provides control of access to particular types of content available to the computer 136 via the Internet or other information network. In such an embodiment, an administrator is able to select, for example, types of information sources, such as chat rooms, music links, web sites having a certain rating, and other information sources. The administrator can then select when or if the various information sources are to be made available. The primary controller 102 then communicates these settings to a remote module for execution.

Although the various modules 104-112 in FIG. 1 are depicted as separate hardware and/or software components, they may be integrated into the device to be controlled. For instance, the AC module 104 may be incorporated into a television 128 or other device. The television 128 or other device may also include embedded software and/or firmware to support the implement the control processes described herein.

For instance, there may be times when one or more of the remotely controlled devices (such as a Playstation Game) may need to be removed from its normal location and transported to a new location for use. Since the control module is physically attached to the device's cable, and once the device is removed out of communication range of the primary controller 102, the device would not be enabled for operation. To overcome this limitation, and to still allow the parent the ability to limit the game's usage, a remote portable controller may be utilized.

The remote portable controller is a device that can be used to carry schedule control information to remote locations that are outside of the primary controller's range. This allows external modules within the system to be transported to different locations, and still provide the same custodial control functionality as they would if they were within the primary controller's range.

The remote portable controller may be implemented in various ways. For example, the remote portable controller may be incorporated into each of the modules 108-112 or may be implemented as a separate controller that acts in the place of the primary controller 102 when the module is outside of communication range, operating under its own integrated, secondary-controlling functions. In such a controller, while still at the originating location, the primary controller 102, under custodial control, wirelessly commands the remote portable controller with all of the controlling information required to regulate the game's usage when away from its original location. The remote portable controller is then transported along with the device (game in this case), and provides all of the activation/deactivation controls for the game, on a time schedule set-up by the parent. The remote portable controller then communicates this control information to the game control module, which is still connected to the game, wirelessly, in the same way that the primary controller 102 would have done, had it been in proximity. Such a module includes a “Real Time Clock” as well as memory storage space so that once the primary controller 102 uploads schedule information, the ON/OFF control is handled by the remote portable control module for a period as programmed.

The system may also include a telephone control module that controls the use of a landline wired or wireless telephone used in conjunction with the control module. Such a control module may have an input for the outgoing line and for the telephone or telephone base station.

The various control modules may be available to a user in various ways. For instance, the user may purchase a “starter set” that includes the primary controller 102 and a television control module 106. Additional modules may be purchased and added to the system as desired by the user.

### Mechanical Configuration of Remote Nodes

The remote modules may be designed in such a way that all incoming and outgoing cables are retained within the housing, once the housing is closed. The retention mechanism shall be such that even if a cable is pulled, the cables' connector will not become disengaged internally from its socket. For those remote modules that use batteries, the batteries shall be accessible externally without the need of opening the enclosure.

The remote modules shall incorporate the use of a locking mechanism that prevents the enclosure from being opened, thus disallowing unauthorized persons from removing any of the cables that are plugged into that module.

The locking mechanism may either be a mechanical lock and key method, or alternatively an electromechanical locking mechanism. If a mechanical lock and key method is chosen, the lock shall prevent the remote module from being opened without the use of an appropriate key. If an electromechanical locking mechanism is chosen, the enclosure will only open after the systems' primary controller issues an appropriate unlock communication signal. This unlock signal can only be initiated by the system administrator. Once unlocked, by either locking method selected, the enclosure may be easily opened and access to the retained cabling, or cabling locations, is gained. This feature is used on initial installation, or in a case where the remote module is being relocated, or when a module is removed from a system.

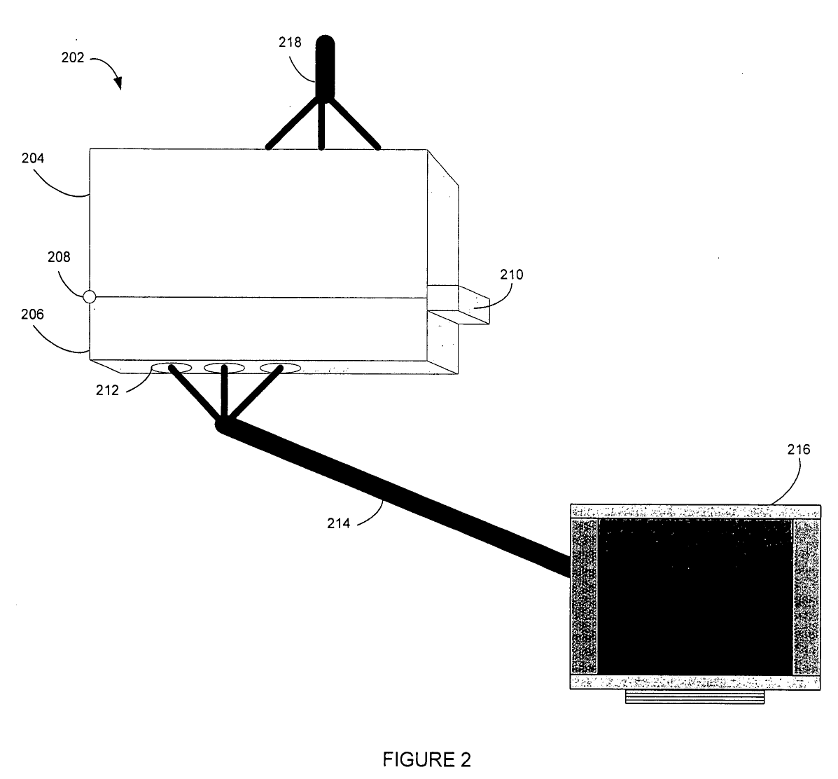

FIG. 2 is a block diagram illustrating a game console control module in one embodiment of this invention. In FIG. 2, the elements are not shown to scale. For example, the game console control module 202 is generally smaller than the television or video monitor to which it is attached. The game console control module 202 comprises a first portion 204 and a second portion 206. In FIG. 2, the first portion 204 is shown on top and the second portion 206 is shown on the bottom, but various implementations may be used. Further, although the module 202 is shown as a rectangle, a variety of shapes may be utilized.

The first portion 204 and second portion 206 are connected by a hinge 208 and will thus open. When in the closed position as illustrated in FIG. 2, they are held together by a locking mechanism 210. The locking mechanism 210 may be a lock with a key hole (not shown) or an electromagnetic lock.

The second portion 206 of the module 202 includes several holes, such as hole 212. The hole 212 is shown as circular but many other shapes may be utilized. For example, a slot may be utilized to facilitate inserting a cable while securing the connector on the end of the cable.

In the embodiment shown, one of the three wires from a game console-type cable 214 is present in the hole 212. The connector end of the cable 214 is not shown since it is secured inside the module 202. The other end of the cable is attached to the television 216. A second cable 218 is connected to the module 202 through the top portion 204 and attached to a game console (not shown). In various implementations of this invention, the cables may enter the same side of the module. Also, one or both of the cables may be secured within the module 202.

While the locking mechanism 210 is secured, the cable 214 cannot be removed. Accordingly, the module 202 controls the signals that the television 216 receives.

### Inter-Node Communication

A system according to an embodiment of this system may use a wireless communication technology to provide communications between the primary controller and the various modules. Various available technologies may be used, such as Bluetooth, WiFi or other WAN or PAN networks. The modules may utilize ZigBee technology. ZigBee technology is intended for small personal networks (PAN), is low cost, is low power, and supports mesh type networking. Mesh networking is a method by which all modules within a given network may operate as repeaters of the communication signals. By utilizing mesh technologies, modules, including the primary controller, are able to pass communication packets from module to module. This extends the range of any particular module by hopping messages from one module to another, allowing a message to be received by an otherwise out-of-range module. The one-hop range (one module to another) may be no less than 30 meters; in some embodiments, it may be less than 30 meters to infrastructure or environmental variables. By using mesh technology, only the total number of modules and the physical distribution of the modules limit the effective system range.

The communication signals being sent or received within this system may be encrypted using an encryption key. This provides secure control over the various modules within the system. The encryption key may be a 128-bit encryption key.

For all hardware modules, temporary loss of communications, such as that resulting from temporary loss of power, may not cause any loss of programmed memory or sense of real time. Once communication is restored the module will continue normal operation. During the time that communication is lost, the module will default to an operating condition that maximizes custodial control and safety—generally, the implementing an “OFF” condition.

The primary controller may communicate directly with any of the associated modules that are located in an area within the communication sphere of the primary controller. In a mesh network, the communication range of the primary controller is extended by communication sphere around any of the modules with which the primary controller can communicate.

### Automatic Identification/Status of Remote Nodes

One of the operational features of the system may be automatic identification of all available modules within the network range. When a new module is brought into the system's wireless range, the primary controller will locate it and add it to the list of available modules. The administrator will then have the ability to access this module and edit any of its control features, as well as establish access controls and schedules for its use.

If an existing module is removed from the system's wireless network range, this action will be automatically identified and the administrator will have the option to either delete it from the available module list, or retain it on the list. If retained on the list, a status message shall be provided that reminds the administrator that the module is missing from the network.

All modules will report their operating status to the primary controller, when inside of the system's network range. The system administrator may be alerted, via the primary controller's display, whenever the battery level of any of the modules within the network drops below a certain capacity level.

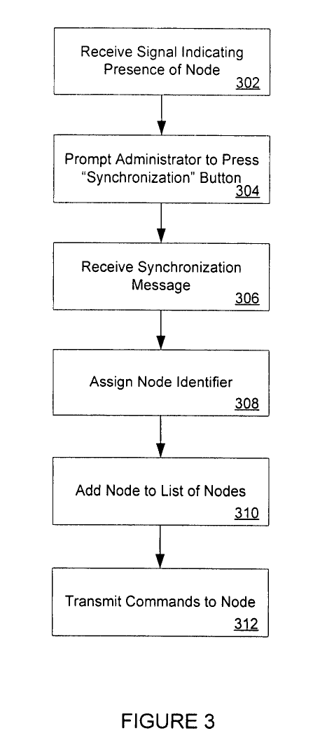

One of the operational features of a system according to an embodiment of this invention may be automatic identification of all available modules within the network range. FIG. 3 is a flowchart illustrating a method of identifying a new node in one embodiment of this invention. In the embodiment shown, when a new module is brought into the system's wireless range, the primary controller receives a signal indicating the presence of the newly introduced node or module 302. The system then prompts the system administrator, via the primary controller display screen, to press the “synchronization button” located on the newly introduced node 304.

The primary controller receives the synchronization message 306. Activation of the synchronization button allows the primary controller to positively determine that the newly introduced module is indeed intended as a part of this system.

The primary controller then assigns an identifier to the node 308 and adds the node to the list of available nodes 310. The administrator will then have the ability to access this module and edit any of its control features, as well as establish access controls and schedules for its use. Once the access controls and schedules are set, the primary controller generates appropriate commands and transmits them to the newly introduced node 312.

If an existing module is removed from the system's wireless network range, this action will be automatically identified and the administrator will be given the option, via the primary controller's display, to either delete it from the available module list, or retain it on the list. If retained on the list, a status message shall be provided that reminds the administrator that the module is temporarily missing from the network.

All modules will report their operating status to the primary controller when inside the system's network range. These reports will include such things as current control status, remaining battery life and tamper status. All communicated status messages shall include a time and date stamp so the primary controller may know the actual time and day the logged information occurred. Each module will retain its own status log until such time that the primary controller successfully downloads this information. At that time the module in question may erase its status log. Each module shall retain its status log indefinitely, or until the primary controller successfully reads it. The primary controller will maintain a status log for each module within its network, for a period of time selected by the administrator. The default period shall be no less than 30 days. The maximum storage time may be limited by available system memory.

The system administrator shall be alerted, via the primary controller's display, whenever the battery level of any of the modules within the network drops below a certain capacity level. The default setting shall be 25% capacity, however the administrator has the option to alter this setting. A secondary alert setting will also be available that alerts the administrator when the battery level of any module within the network drops below a capacity capability that threatens loss of operation. The default for this setting will be 10% battery capacity, however the administrator will have the ability to edit this setting. This alert shall activate an audible alarm as well as display indication, whereas the previous alert only provides a display indication. The administrator shall always have the ability to over-ride these alert features, or disable them.

### Use and Administration of the System

The primary controller may allow access to its operation, programming, and all setup features through a password protected interface. Other methods of administration may be provided instead.

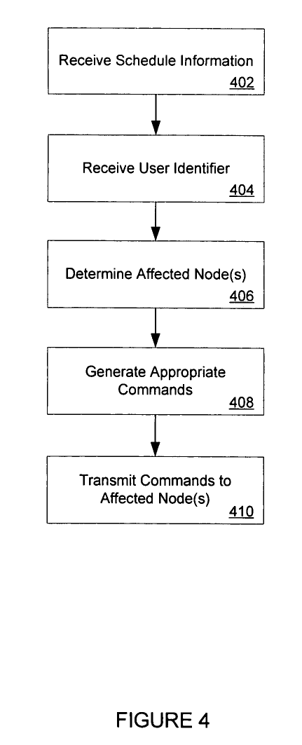

FIG. 4 is a flowchart illustrating a method of administration in one embodiment of this invention. In the embodiment shown, an administrator enters one or more instructions, such as control access or schedule instructions. The primary controller receives these instructions 402.

The primary controller then receives a user identifier 404. The primary controller also identifies the affected node or nodes 406. The primary controller may, for example, determine the affected node by extracting a node identifier from the instruction. Alternatively, the primary controller may determine the devices to which the user has access.

The primary controller then generates the appropriate commands for the remote device 408. For instance, the primary controller may generate a command instructing the remote node to shut off the device. Alternatively, the primary controller may generate a command containing the instructions and schedule so that a remote node can operate as a secondary portable controller. The primary controller then transmits the command to the affected node or nodes 410.

In a password-protected interface, there is an initial default password, however the administrator can change that password at any time. With administrator password entry, it is possible to access all features of the controller, including instant activation/deactivation of any remote module on the network.

The primary controller provides scheduling information for all of the modules within a system. The schedule is set up and managed by the administrator. Whenever a particular module is scheduled to be shut off, the primary controller may issue a communication message to the respective module in advance of the intended shutdown time. At the module, the shutdown message may cause a local audible alert signal to sound, which warns the user that a certain operating time remains. The system administrator selects the actual amount of time. A default time may also be utilized on the control modules, e.g., 2 minutes. The warning signal is intended to allow games to be saved or other operations to be performed prior to the loss of signal. Alternatively, the remote modules may receive signals periodically from the primary controller and then implements the schedule without receiving additional command signals.

The primary controller may accept unique password logins for multiple users. For instance, one system provides for an unlimited number of different users. A distinction is made for the user that is designated as the administrator. The administrator is able to assign and regulate access levels for all other users. With the exception of the administrator login, all other users accessing the system are subject to administrator-controlled access levels and administrator-controlled access schedules.

The primary controller may support multiple access levels, which are assigned by the administrator. The following is a list of access levels in one illustrative system:

Administrator—this access level has the ability to control and alter all programmable features of the primary controller, including the setting of access levels for all other users.

Advanced user—the administrator determines the advanced user access level. This access level may allow another adult certain access rights for a limited period of time, such as a baby sitter, or this level may be assigned on a permanent basis to older users in the household.

Controlled access user—this access level is generally intended for any users accessing the system. While the administrator always has the option to alter these access levels, the default levels will be initially set for maximum custodial control. Further, the administrator may alter access levels on a per-user basis, identified by login password.

Guest—the administrator may choose to assign one or more passwords to this access level. That password can be given over the telephone, or verbally, to anyone the administrator so chooses. With the access pre-assigned by the administrator, the guest will be allowed instant access to whatever level the administrator has set.

In addition to the data entry virtual keyboard and keypad described above, there shall be an editable screen system designed that allows the administrator to quickly create or edit user operating schedules based on day, week, month or year. The scheduling system will facilitate not only specific daily, weekly, monthly and yearly timed schedules, but also the ability to allocate operating time allotments, for specific users, that cease to allow operation when a user's time allotment has been consumed. This scheduling method shall allow the administrator to assign access to specific modules, for a specific user, and also the ability to assign any module, or several, to a specific user. The display will employ user selected dropdown menus to facilitate these setup choices.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of this invention.

That which is claimed:

1. A custodial control system comprising:
a primary controller having a first network adapter, the primary controller configured to receive a custodial control parameter and generate and transmit a custodial control command; and
a plurality of remote nodes each having a network adapter configured to receive the custodial control command and to implement a custodial control process based at least in part on the custodial control command.

2. The custodial control system of claim 1, wherein the first network adapter comprises a wireless network adapter.

3. The custodial control system of claim 1, wherein at least one of the plurality of remote nodes comprises at least one of a television module, a computer module, a game console module, a computer module, an AC (alternating current) module, a direct current (DC) module, a remote portable module, or a telephone module.

4. The custodial control system of claim 1, wherein at least one of the plurality of remote nodes comprises a remote secondary controller.

5. The custodial control system of claim 4, wherein the remote secondary controller comprises a real-time clock.

6. The custodial control system of claim 1, wherein the primary controller transmits the custodial control command over a wireless mesh network.

7. The custodial control system of claim 1, wherein the primary controller comprises a handheld device.

8. The custodial control system of claim 1, wherein at least one of the plurality of remote nodes comprises:
a first housing portion and a second housing portion; and
a locking mechanism configured to seal the first housing portion to the second housing portion when the locking mechanism is locked.

9. The custodial control system of claim 8, wherein a first end of the first housing portion defines a hole configured to accept a cable and further configured to lock the cable in the housing when the locking mechanism is locked.

10. The custodial control system of claim 8, wherein the locking mechanism comprises an electromagnetic lock.

11. The custodial control system of claim 1, wherein the locking mechanism comprises a keyed lock.

12. The custodial control system of claim 1, wherein at least one of the plurality of remote nodes comprises a tamper detection sensor.

13. The custodial control system of claim 12, wherein the tamper detection sensor is configured to transmit a signal to the primary controller.

14. The custodial control system of claim 12, wherein the tamper detection sensor a motion detector.

15. The custodial control system of claim 12, wherein the tamper detection sensor a housing open detector.

16. A method for adding a device to a custodial control system comprising:
recieving a signal indicating the presence of a newly added node;
generating a request for a synchronization signal;
receiving the synchronization signal; and
adding the newly added node to a list of nodes available for configuration.

17. The method of claim 16, further comprising:
receiving an instruction related to control or scheduling of the newly added node;
generating a command associated with the instruction; and
transmitting the command to the newly added node.

18. A method for implementing a custodial control instruction in a custodial control system comprising:
receiving a command indicating that a device associated with a remote node in the custodial control system is to be disconnected from a signal source, the signal source configured to generate a signal, which is one of a video signal, an audio signal, or a control signal; and
disrupting the signal.

19. A custodial control system comprising:
a remote node having a network adapter,
wherein the remote node is configured to receive a custodial control command from a primary controller and to implement a custodial control process based at least in part on the custodial control command.

20. The custodial control system of claim 19, wherein the network adapter comprises a wireless network adapter.

21. The custodial control system of claim 19, wherein the remote node comprises a remote node selected from the list consiting of a television module, a computer module, a game console module, a computer module, an AC (alternating current) module, a direct current (DC) module, a remote portable module, or a telephone module.

22. The custodial control system of claim 19, wherein the remote nodes comprises a remote secondary controller.

23. The custodial control system of claim 22, wherein the remote secondary controller comprises a real-time clock.

24. The custodial control system of claim 19, wherein the primary controller transmits the custodial control command over a wireless mesh network.

25. The custodial control system of claim 19, wherein the primary controller comprises a handheld device.

26. The custodial control system of claim 19, wherein the remote node comprises:
a first housing portion and a second housing portion; and
a locking mechanism configured to seal the first housing portion to the second housing portion when the locking mechanism is locked.

27. The custodial control system of claim 26, wherein a first end of the first housing portion defines a hole configured to accept a cable and further configured to lock the cable in the housing when the locking mechanism is locked.

28. The custodial control system of claim 26, wherein the locking mechanism comprises an electromagnetic lock.

29. The custodial control system of claim 19, wherein the locking mechanism comprises a keyed lock.

30. The custodial control system of claim 19, wherein the remote node comprises a tamper detection sensor.

31. The custodial control system of claim 30, wherein the tamper detection sensor is configured to transmit a signal to the primary controller.

32. The custodial control system of claim 30, wherein the tamper detection sensor a motion detector.

33. The custodial control system of claim 30, wherein the tamper detection sensor a housing open detector.
